(19) United States
(12) Patent Application Publication
(10) Pub. No.: US 2012/0246878 A1
(43) Pub. Date: Oct. 4, 2012

(54) RAIN PROTECTIVE SPORTS TOWEL

(76) Inventor: Tim I. Holdsworth, Coshocton, OH (US)

(21) Appl. No.: 13/435,203

(22) Filed: Mar. 30, 2012

Related U.S. Application Data
(60) Provisional application No. 61/470,533, filed on Apr. 1, 2011.

(51) Int. Cl. D01G 13/00; F26B 13/24

(52) U.S. Cl. 19/145; 34/95

(57) ABSTRACT

A rain protective towel for use in association with sporting events, work endeavors, or general use is provided. Also presented are methods of manufacturing of such a towel. In general, the towel is formed of a terrycloth or other cotton water absorbent material, which is rendered waterproof or rain resistant by being subjected to a bath of a water-diluted water repellant fluoropolymer that is allowed to permeate the cloth. The edges of the towel are bound or otherwise finished, and the towel may have any of various desired aesthetic designs thereon. The towels may be formed from processing a web of terrycloth material through a bath of diluted water repellant fluoropolymer, thence through a wringer, various dryer stations, a station for printing, embroidering or embossing and subsequent stations for cutting and edge binding. Alternative processes are disclosed.

### CROSS REFERENCE TO RELATED APPLICATION

This regular utility application claims priority to provisional application Ser. No. 61/470,533, filed Apr. 1, 2011, such application bearing the same title.

### TECHNICAL FIELD

The invention herein resides in the art of towels and the like and, more particularly, to a sports or utility towel that is rendered waterproof and can serve as a protective cover for sports and utility equipment. More particularly, the invention is a sports or utility towel, and its method of manufacture, which allows a common terrycloth towel, typically employed for its water absorbency, to be rendered water repellant and used as a rain shied or the like.

### BACKGROUND OF THE INVENTION

Many sports and other activities are conducted even when it rains, or with breaks being taken to allow the rain to pass. In the event of sports activities, the sports equipment often needs to be protected from the rain either during a “rain delay” or intermittently while play continues during the rain. In work or other utilitarian activities, work equipment also needs to be protected, either during such period of time as is necessary to allow the rain to subside, or intermittently while the work activity continues during the rain.

By way of example, and not limitation, golfers play golf even during the rain and, when rain occurs, there is a need to protect the golf equipment, and especially the clubs, from becoming wet or damaged by the rain. While some golf bags are equipped with a cover that snaps onto the golf bag and which serves to protect the clubs from the rain, many golf bags are not so equipped. Moreover, the snap-on type of cover is typically bulky and cumbersome, and not given to ease of storage while in play. The need for protection of sports equipment extends to baseball gloves, bats, footballs, soccer balls, lacrosse equipment, and the like.

In work environments, outdoor workers, from the professional to the homeowner, are often confronted with unannounced rains that impede their work and might otherwise harm or damage their equipment. When users of farm tractors or riding lawnmowers are confronted with rain, they often leave the equipment outside while running for shelter. When they return, the seat is covered with rainwater, making the remainder of the operation uncomfortable. When the rains interrupt an activity employing a piece of power equipment, such as a power hedge trimmer, chain saw, powered hand mower, or the like, the rain may often drive the user to seek shelter while leaving the equipment at the worksite where it may be damaged.

There is a need in the art for a method of manufacture and the resulting towel that can be waterproof, while being lightweight, easy to store, and sufficiently soft that it poses no hazard of damaging the material being protected from the rain. There is particularly a need in the art for the provision of such a towel which is inexpensive to manufacture, easy to carry and store, and which can be adapted to a broad range of uses in a reliable and cost effective manner. Particularly, there is a need in the art for a rainproof or water resistant cloth or towel that may be used to cover a wide range of pieces of sports utility equipment, and which may even be used to make apparel, pet wear, stadium seat covers and the like. Indeed, the applications for such towels or cloths are seemingly endless.

### SUMMARY OF INVENTION

In light of the foregoing, it is a first aspect of the invention to provide a rain protective towel that is soft and durable, yet impervious to rain.

Another aspect of the invention is the provision of a rain protective towel that is sized to accommodate the protection of various sports and utility items, while still rendering itself to storage convenience.

Still a further aspect of the invention is the provision of a rain protective towel that is attractive and utilitarian in use.

Still another aspect of the invention is the provision of a methodology for developing a rain protective towel which accommodates the manufacture of a plurality of such towels in an efficient and cost effective manner.

Yet another aspect of the invention is the provision of a methodology for manufacturing a rain protective towel which accommodates the rendering of a terrycloth material to be waterproof.

Still another aspect of the invention is the provision of a methodology for manufacturing a rain protective towel in which a terrycloth material is rendered waterproof, imprinted, embossed or embroidered, and cut to desired sizes and bound at the edges to provide a reliable and durable product.

The foregoing and other aspects of the invention that will become apparent as the detailed description proceeds are achieve by: a rain protective towel, comprising; a body portion of normally hydrophilic cloth material, said cloth material having been rendered waterproof; a border about a perimeter of said body portion, said border being finished to prevent said cloth material from unraveling; and an aesthetic design imparted to said body portion of a type taken from a group of screen printing, embroidering or embossing.

Yet other aspects of the invention that will become apparent herein are achieved by a method for making rain protective towels, comprising: feeding a web of cloth material through a bath of water repellant solution; wringing said water repellant solution from said web of cloth material; drying said web of cloth material; imparting a design onto selected areas of said web of cloth material; cutting selected portions of said cloth material from said web; and binding a perimeter edge of said selected portions, thereby finishing a rain protective towel.

Still further aspects of the invention are achieved by a method for making rain protective towels, comprising: feeding a web of cloth material through a cutter and cutting selected portions of said cloth material from said web; binding peripheral edges of said portions of said cloth material; placing said portions of said cloth material in a bath of water repellant solution for a predetermined period of time; wringing said water repellant solution from said portions of said cloth; drying said potions of said cloth; applying a design onto said portions of said cloth; and stacking said portions as rain protective towels.

### DESCRIPTION OF DRAWINGS

For a complete understanding of the various aspects and techniques of embodiments of the invention, reference should be made to the following detailed description and accompanying drawings wherein:

FIG. 1 is a top plan view of a rain protective towel according to the invention;

FIG. 2 is a flow diagram of a process according to an embodiment of the invention for manufacturing the towel of FIG. 1;

FIG. 3 is a functional flow diagram showing the apparatus and process of an embodiment of the invention for manufacturing the towel of FIG. 1; and

FIG. 4 is a functional flow diagram of another embodiment of the invention for manufacturing the towel of FIG. 1.

### BEST MODE FOR CARRYING OUT THE INVENTION

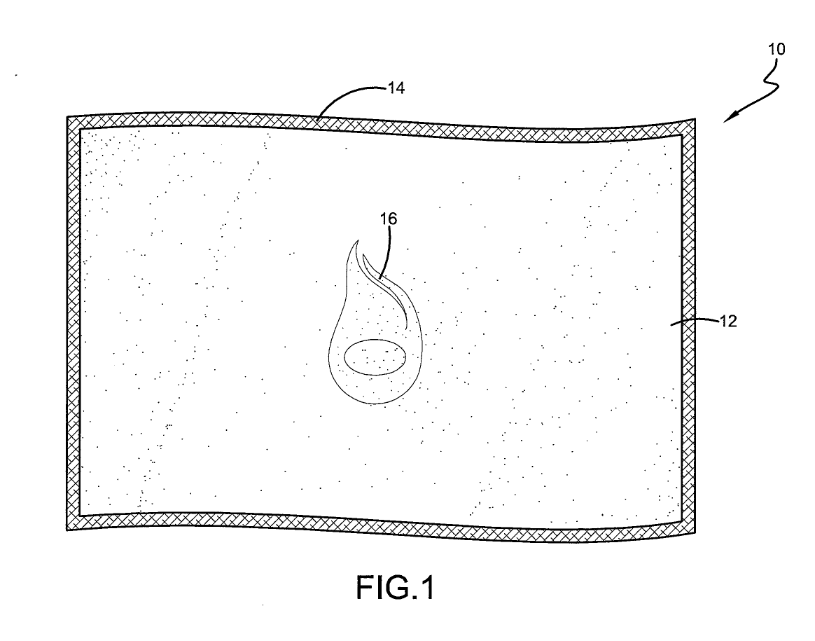

Referring now to the drawings and more particularly to FIG. 1, an appreciation can be obtained with regard to the structure of a rain protective towel made in accordance with an embodiment of the invention. As shown in FIG. 1, a rain protective towel is designated generally by the numeral 10 and consists of a body 12 formed of terrycloth or other appropriate towel material. It will be appreciated that such material is normally absorptive and of a hydrophilic nature, with the material of the body 12 according to embodiments of the invention having been treated to cause it to be hydrophobic or waterproof. At the very least, the material of the body 12 has been treated to the cause it to be rain resistant. The body 12 is hemmed or otherwise bound about its peripheral border 14 as by stitching or the like. It may also be fused or bonded. In any event, the border 14 is appropriately finished to preclude the terrycloth or other material from unraveling.

Optionally, a design 16 may be placed upon the body 12 of the rain protective towel 10 by any of various appropriate means, such as screen printing, embroidering, embossing or the like. The design 16 may have any of various configurations, generally dependent upon and indicative of the intended use of the towel 10.

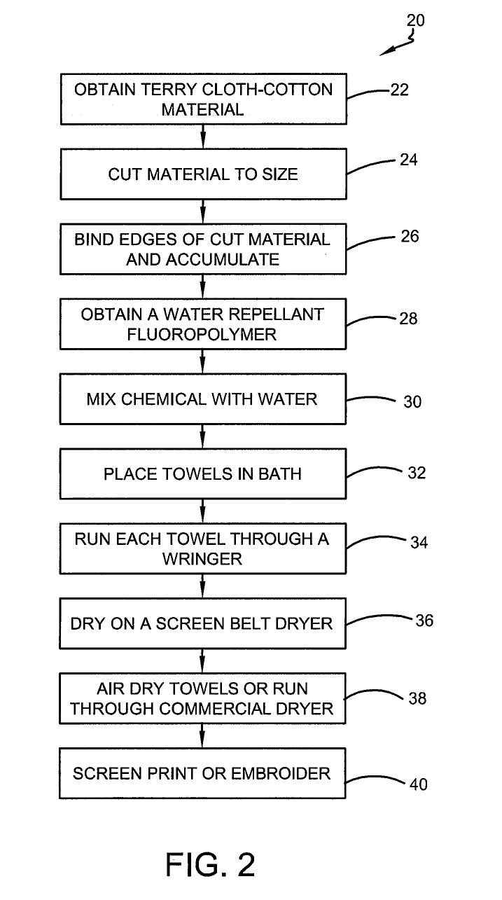

With reference now to FIG. 2, an appreciation can be obtained with regard to a process of an embodiment of the invention for making the towels 10. The process is designated generally by the numeral 20 and consists of the general steps 22-40 as presented in the flow chart. Those skilled in the art will appreciate that the steps are not necessarily in sequential order, but the ordering of the steps may be changed in accordance with various embodiments of the invention. As a representative process, a terrycloth or other appropriate cotton material may be obtained, such as from a fabric store or directly from a manufacturer, as at 22. Preferably, an entire bolt of the material is purchased. At 24, the web of material taken from the bolt at 22 may be cut to size, such size depending upon its ultimate intended use. Further, depending upon the width of the bolt of material purchased, the material may be cut both longitudinally and laterally across the material sheet or web. At 26, the edges of the cut material are bound, as by sewing or the like. The cut material, representing the bodies 12 of the desired towel 10 are then accumulated.

At 28, an appropriate composition for preparing a bath of water repellant material is obtained. According to one embodiment of the invention, an appropriate bath may be prepared from a water repellant fluoropolymer such as RAINOFF® FX 6600 manufactured by Eastern Color and Chemical Company of Providence, R.I. The material is a fluoropolymer blend textile repellant and soil release agent, intended only to be sprayed onto the surface of various fabrics. The desired bath includes such a fluoropolymer blend, which is soluble in water, having a specific gravity on the order of 1.03 and volatiles at a concentration of 66%.

At 30, a bath is made by diluting the water repellant fluoropolymer obtained at 28 with water in a range of 8:1 to 14:1 of water to fluoropolymer. Preferably the dilution is on the order 10:1.

At 32, a quantity of the accumulated cut and bound materials generated at 26 are placed in a wringer washer containing the bath of step 30 and the towels are agitated for a period of 5-15 minutes, and more preferably on the order of 10 minutes. It will appreciated that the activity at step 32 may not require agitation, but the cut and bound material may be allowed to simply soak in a tub without agitation, but generally for a longer period of time such as 10-20 minutes, and preferably 15 minutes. Of course, those skilled in the art will find that the dwell time for the terrycloth-type material in the bath may vary with the density or weight of the cloth material itself and the nature of any agitation. The ultimate desire is to allow the bath solution to permeate the cloth material, rather than simply surface treat it.

At 34, each of the towel pieces is run through a wringer from between one and three times, depending upon the effectiveness and efficiency of the wringer itself. At step 34, the desire is to remove as much of the bath solution as possible from the towel pieces, with the bath solution being returned to the washer or tub.

The towel pieces are then flattened onto a screen belt dryer at 36, and allowed to remain there from 2-4 minutes, at a temperature of 250-400° F., on a first side and then the towel pieces are turned over for a similar residency on the screen belt dryer on the other side. Each towel piece remains on the screen belt dryer for approximately 2.4 minutes, and preferably 3 minutes at approximately 325° F. on each side.

The towel pieces are then removed from the screen belt dryer and air dried as at 38 by running through a commercial dryer at ambient temperature on the order of 10-30 minutes, and most preferably on the order of 20 minutes. In the commercial dryer at step 38, the towel pieces may tumble or remain stationary as the air passes around them.

At 40, the material or towel pieces are ready to be screen printed, embroidered, embossed or otherwise finished.

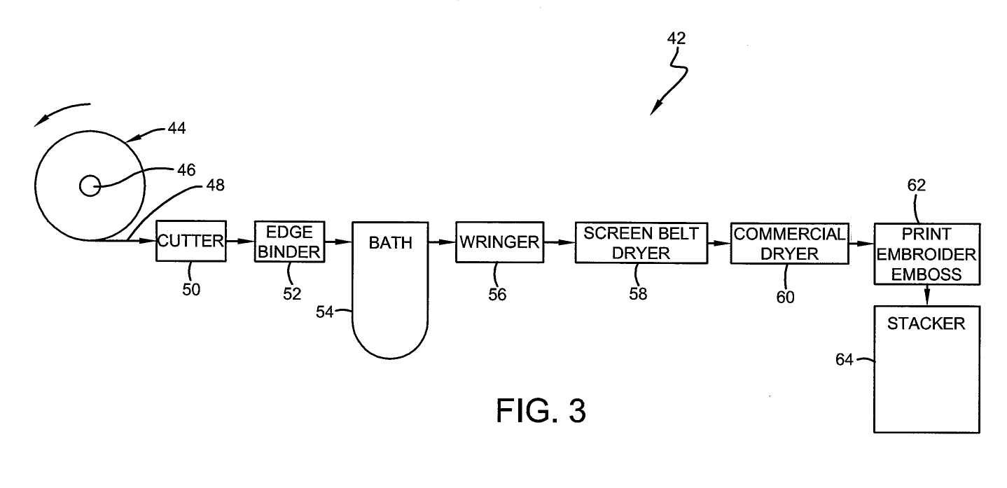

With an appreciation of the general process of the development and manufacture of the rain protective towels 10, an appreciation can be obtained of the apparatus and process for such manufacture according to various embodiments of the invention. With reference now to FIG. 3, it can be seen that a first embodiment of a process for manufacturing the rain protective towels 10 may be seen as designated generally by the numeral 42. Here, a large bolt or supply feed roll of terrycloth or other towel cloth is designated generally by the numeral 44. The supply feed role 44 will contain the cloth material at any of various desired widths. The feed roll 44 is rotatable upon and about a spindle or axle 46. A web 48 of the terrycloth or other material is drawn from the supply feed roll 44 and passes first to a cutter 50, where towel body portions 12 are formed. Depending upon the width of the supply feed roll 44, the cutting operation at 50 may include both longitudinal and lateral cuts on the web 48.

The cut material then passes from the cutter 50 to the edge binder 52, where appropriate peripheral stitching, sewing and binding and/or bonding occurs about the periphery of the body pieces 12.

The bound pieces are then passed from the binder 52 to the bath 54, containing a diluted solution of water repellant fluoropolymer, as discussed above. The bath 54 may include an agitator of any of various natures, and the dwell time within the bath 54 will be according to the discussion presented above.

Upon completion of the bath, the body pieces 12 are removed, passed through an appropriate wringer 56 and onto a screen belt dryer 58, and then through a commercial dryer 60, all as discussed above with regard to the process flowchart of FIG. 2. Thereafter, the dried an edge-bound body pieces 12 are passed to a station 62 where appropriate designs 16 may be printed, embroidered, or embossed thereon. The finished rain protective towel 10 is then passed to an appropriate stacker 64, for packaging or other processing.

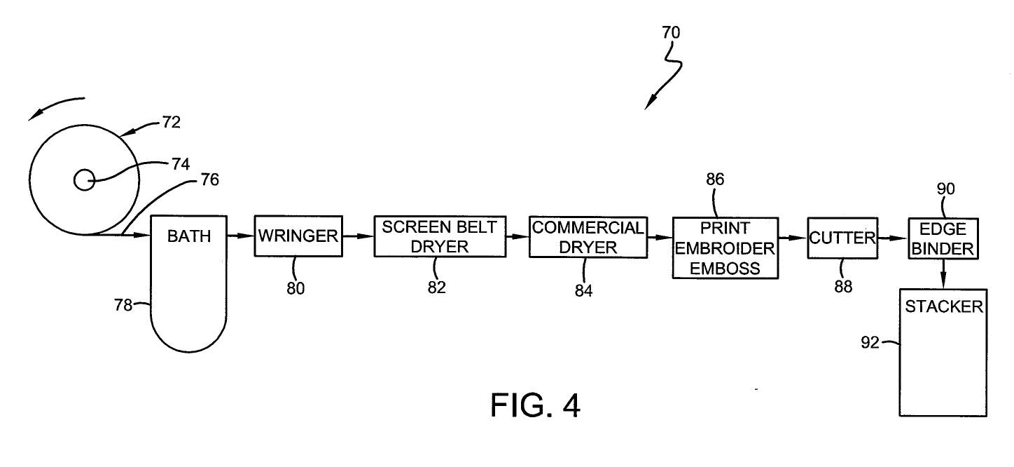

In accordance with another embodiment of the invention, process system 70 of FIG. 4 may be employed. Here, a feed supply roll 72 is maintained upon and rotatable about an axle 74 to dispense a web 76 of appropriate material for forming the rain protective towel 10. In this embodiment, a continuous web 76 is first passed through a bath of the diluted water repellant fluoropolymer as discussed above, with or without agitation and generally for the time periods as earlier stated. The continuous web then passes through one or more wringers as at 80 and onto the screen belt dryer 82, through the commercial dyer 84, and to the station for printing, embroidering and embossing at 86. At this point, a continuous web of material suitable for cutting to size and edge-finishing to form the rain protective towels 10 is present. Accordingly, the continuous web then passes to the cutter 88, which performs the necessary lateral and/or longitudinal cuts to define predetermined sizes for the rain protective towel 10. These cut pieces, are then passed from the cutter 88 to the edge binder 90, where the perimeters are stitched, sewn, bound, and/or bonded to finish the towel 10. The finished products are then passed to the stacker 92 for further appropriate processing.

Those skilled in the art will appreciate that other processes and techniques may be employed consistent with the foregoing to manufacture the rain protective towels 10. By appropriately treating a material typically employed for its hydrophilic or water absorbing nature, and to convert it to a hydrophobic material such that it is waterproof or at least rain resistant, the steps and processes outlined above maybe followed, although the specific processes and techniques, and order of events may vary.

It will be appreciated that the physical size of the rain protective towels 10 may vary to accommodate various uses. Those for protecting sports equipment of various sizes will necessarily vary, as will those for covering utility equipment such as tractor seats, lawn mowers or hand tools. Moreover, the uses to which the towels or cloth made according to the invention may be put are expansive, extending not only to sports and utility equipment, but apparel, pet wear, stadium seat covers and the like.

Thus it can be seen that the various aspects of the invention have been attained by the structure and process presented above. While in accordance with the patent statutes, only the best mode and preferred embodiments of the invention have been presented and described in detail, the invention is not limited thereto or thereby. Accordingly, for an appreciation of the scope and breadth of the invention reference should be made to the following claims.

What is claimed is:

1. A rain protective towel, comprising;
a body portion of normally hydrophilic cloth material, said cloth material having been rendered waterproof;
a border about a perimeter of said body portion, said border being finished to prevent said cloth material from unraveling; and
an aesthetic design imparted to said body portion of a type taken from a group of screen printing, embroidering or embossing.

2. The rain protective towel according to claim 1, wherein said cloth material is terrycloth.

3. The rain protective towel according to claim 2, wherein said cloth material is rendered waterproof by permeation of a water repellant fluoropolymer.

4. A method for making rain protective towels, comprising:
feeding a web of cloth material through a bath of water repellant solution;
wringing said water repellant solution from said web of cloth material;
drying said web of cloth material;
imparting a design onto selected areas of said web of cloth material;
cutting selected portions of said cloth material from said web; and
binding a perimeter edge of said selected portions, thereby finishing a rain protective towel.

5. The method for making rain protective towels according to claim 4, further comprising a step of preparing said bath of water repellant solution by diluting a water repellant fluoropolymer with water.

6. The method for making rain protective towels according to claim 5, wherein said step of drying comprises conveying said web on a screen belt dryer.

7. The method for making rain protective towels according to claim 6, wherein said step of drying further comprises passing said web through an air dryer.

8. The method for making rain protective towels according to claim 7, wherein said step of binding is taken from the group of sewing, stitching and bonding said perimeter.

9. The method for making rain protective towels according to claim 8, further comprises the step of stacking said rain protective towels.

10. A method for making rain protective towels, comprising:
feeding a web of cloth material through a cutter and cutting selected portions of said cloth material from said web;
binding peripheral edges of said portions of said cloth material;
placing said portions of said cloth material in a bath of water repellant solution for a predetermined period of time;
wringing said water repellant solution from said portions of said cloth;
drying said potions of said cloth;
applying a design onto said portions of said cloth; and
stacking said portions as rain protective towels.

11. The method for making rain protective towels according to claim 10, wherein said water repellant solution comprises a water diluted water repellant fluoropolymer.

12. The method for making rain protective towels according to claim 11, wherein said step of applying a design comprises imprinting.

13. The method for making rain protective towels according to claim 11, wherein said step of applying a design comprises embroidering.

14. The method for making rain protective towels according to claim 11, wherein said predetermine time is 5-15 minutes.

15. The method for making rain protective towels according to claim 11, wherein said step of drying comprises placing said portion of said cloth onto a screen belt driver at a temperature of 250° F.-400° F. for a period of 2-4 minutes on each side.

16. The method for making rain protective towels according to claim 15, wherein said step of drying further comprises placing said portion of said cloth into an air dryer at ambient temperature for 10-30 minutes.
